(19) United States
(12) Patent Application Publication
(10) Pub. No.: US 2013/0246317 A1
(43) Pub. Date: Sep. 19, 2013

(54) SYSTEM, METHOD AND COMPUTER READABLE MEDIUM FOR IDENTIFYING THE LIKELIHOOD OF A STUDENT FAILING A PARTICULAR COURSE

(71) Applicant: BRUCE MARTIN, BRISBANE, CA (US)

(72) Inventor: BRUCE MARTIN, BRISBANE, CA (US)

(73) Assignee: SOPHIA PURCHASER COMPANY, L.P., MALVERN, PA (US)

(21) Appl. No.: 13/418,933

(22) Filed: Mar. 13, 2012

(51) Int. Cl. G06F 15/18

(52) U.S. Cl. 706/12

(57) ABSTRACT

Systems and methods for assessing the likelihood of a student of an educational institution failing a particular course taken by the student. Configuration data that identifies, for a particular course, a plurality of grade book applications, a plurality of student information systems, and a plurality of learning management systems is stored in the memory of a computing device. A processor receives, via adapters, input data from grade book applications, student information systems, and learning management systems. The adapters transform the input data into a standard risk model for the processor to generate, based on the received risk data, a signal indicative of a likelihood of a student failing a particular course.

### TECHNICAL FIELD

The present application relates to educational risk analysis, and more specifically, assessing the likelihood of a student failing a particular course.

### BACKGROUND

As the focus on education increases, educators and parents of students face challenges regarding both the quality and the effectiveness of the education being provided to students.

At primary and secondary levels of education, educators have the responsibility to effectively teach students and to prepare students for education at the university or college level. Similarly, at the university level, educators focus on effective methods of teaching in order to prepare students and give them the tools to be successful for life after school. Educators at the university level face the additional institutional pressure of maintaining the university's academic statistics for university ranking purposes.

With the rising costs of education, parents of students and students themselves also are concerned with the effectiveness of educators and value of the education they are receiving. Parents and students often have little idea of the student's classroom performance until grades are received, at which point, there is little time to remedy any negative performance.

### SUMMARY

Systems and methods for assessing the likelihood of a student of an educational institution failing a particular course taken by the student are disclosed. In one embodiment, a computer-implemented method for assessing, in a computer system comprising a processor and a memory, a likelihood of a student of an educational institution failing a particular course taken by the student, comprises storing in the memory configuration data that identifies, for the particular course, a selected one of a plurality of grade book applications, a selected one of a plurality of student information systems, and a selected one of a plurality of learning management systems. The method further comprises receiving, via a first adapter that executes on the processor, first input data from the selected grade book application identified in said configuration data and transforming the first input data into first data of a risk model specific to the particular course; receiving, via a second adapter that executes on the processor, second input data from the selected student information system identified in said configuration data and transforming the second input data into second data of the risk model; and, receiving, via a third adapter that executes on the processor, third input data from the selected learning management system identified in said configuration data and transforming the third input data into third data of the risk model. The method further comprises generating, by the processor, based on at least the first, second and third data of the risk model, a signal indicative of a likelihood of the student failing the particular course.

A computer-based system for assessing a likelihood of a student of an educational institution failing a particular course taken by the student is also disclosed. In one embodiment, the system comprises a processor, a memory, configuration data, a first adapter, a second adapter, a third adapter, and a risk calculator. The configuration data may be stored in the memory, and identifies, for the particular course, a selected one of a plurality of grade book applications, a selected one of a plurality of student information systems, and a selected one of a plurality of learning management systems. The first adapter executes on the processor and receives first input data from the selected grade book application identified in the configuration data and transforms the first input data into first data of a risk model specific to the particular course. The second adapter executes on the processor and receives second input data from the selected student information system identified in said configuration data and transforms the second input data into second data of the risk model. The third adapter executes on the processor and receives third input data from the selected learning management system identified in said configuration data and transforms the third input data into third data of the risk model. The risk calculator executes on the processor and generates, based at least on the first, second and third data of the risk model, a signal indicative of a likelihood of the student failing the particular course.

### BRIEF DESCRIPTION OF THE DRAWINGS

The foregoing summary, as well as the following detailed description of illustrative embodiments, is further understood when read in conjunction with the appended drawings. For purposes of illustrating the subject matter, there is shown in the drawings exemplary embodiments of the subject matter; however, the presently disclosed subject matter is not limited to the specific methods, instrumentalities, devices and systems disclosed. In addition, the drawings are not necessarily drawn to scale. In the drawings:

FIG. 1 is a block diagram that illustrates one embodiment of an architecture of a risk assessment system that assesses the likelihood of a student failing a particular course.

FIG. 2 illustrates one embodiment of a view of a home page of a faculty member of an educational institution.

FIG. 3 illustrates one embodiment of a user interface that allows a faculty member to set grade point ranges and dates for activity in a learning management system.

FIG. 4 illustrates one embodiment of a user interface that allows a faculty member to select grade book columns used when calculating risk signals.

FIG. 5 illustrates one embodiment of a user interface that allows a faculty member to view risk signals 118 prior to notifying the students via email.

FIG. 6 illustrates one embodiment a user interface that allows a faculty member to send risk signals.

FIG. 7 illustrates one embodiment of a method of configuring risk calculation data.

FIG. 8 illustrates one embodiment of a method of risk calculation data acquisition.

FIG. 9 illustrates one embodiment of an abstract model for risk data.

FIG. 10 illustrates one embodiment of an interface of an adapter for a Learning Management System.

FIG. 11 illustrates one embodiment of an interface of an adapter for a grade book application.

FIG. 12 illustrates one embodiment of an interface of an adapter for a student information system.

FIG. 13 illustrates further details of one embodiment of an abstract model for risk data.

FIG. 14 illustrates one embodiment of a method of calculating risk signals of a student.

FIG. 15 illustrates one embodiment of a method of calculating risk signals using historical training data.

FIG. 16 illustrates one embodiment of a method of calculating risk signals using a formula.

FIG. 17 is a block diagram of one embodiment of a computer system in which aspects of the disclosed systems and methods may be embodied.

### DETAILED DESCRIPTION OF ILLUSTRATIVE EMBODIMENTS

This detailed description is not intended to limit the scope of the claimed subject matter. Rather, the inventors have contemplated that the claimed subject matter might also be embodied in other ways, to include different steps or elements similar to the ones described in this document, in conjunction with other present or future technologies. Additionally, it should be understood that the following embodiments may be performed by hardware, software or a combination of both. Moreover, although the term “step” may be used herein to connote different aspects of methods employed, the term should not be interpreted as implying any particular order among or between various steps herein disclosed unless and except when the order of individual steps is explicitly described. The following description is illustrative and non-limiting to any one aspect.

Disclosed are systems, methods and computer readable medium for assessing the likelihood of a student of an educational institution failing a particular course taken by the student.

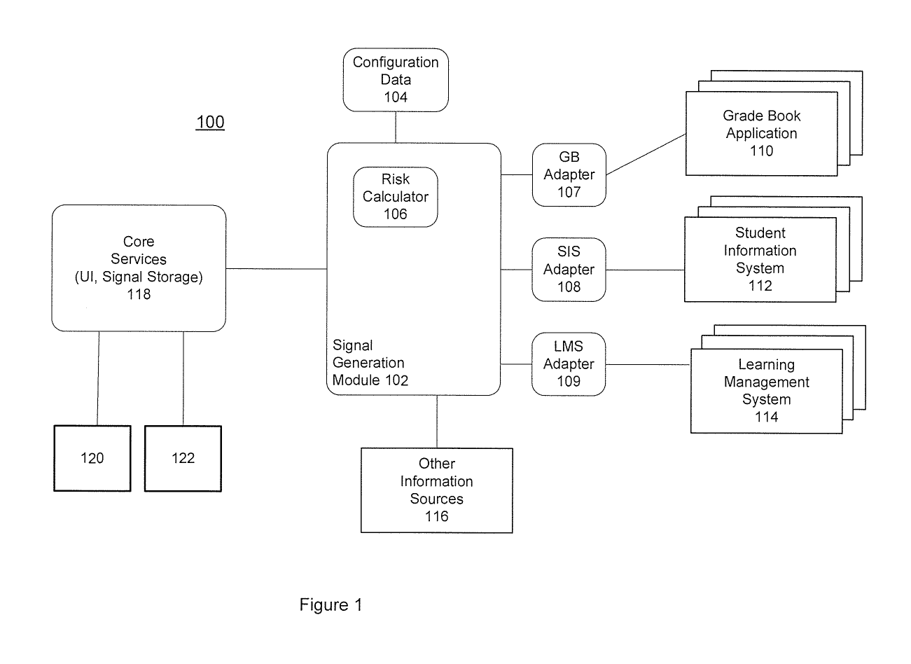

FIG. 1 is a block diagram of one embodiment of an architecture of a computer-based system 100 for assessing the likelihood of a student of an educational institution failing a particular course taken by the student. In this embodiment, the system evaluates each student in a course based on his or her effort, performance, demographic background and academic preparation. That information may be gathered from multiple sources, including a grade book application, a learning management system (LMS), and a student information system (SIS).

A grade book application is typically used by a course instructor to record students' grades, attendance and other data for a particular course(s). Several known grade book applications include learning management systems, Engrade and Excel spreadsheets. Learning management systems typically provide for the administration, documentation, tracking and reporting of courses, classroom and online events, e-learning programs, and course content. Examples of known learning management systems include Blackboard, Desire2Learn, Moodle and Sakai. Student information systems typically assist in managing student data and may store information related to student demographics, medical records, scheduling, intervention plans, attendance, discipline, grades, test scores, standards and competencies, mark reporting, transcripts, and/or other student-related data. Examples of known student information systems include Banner, Power Campus, Datatel and PeopleSoft Student System.

The system 100 may work with a variety of different grade book applications, learning management systems and student information system. As part of a configuration process, configuration data 104 is generated, on a course-by-course basis, that identifies a selected gradebook application 110, a selected student information system 112, and/or a selected learning management system 114 to which the system interfaces and from which the system receives data about the students in the particular course. Thus, the system provides course-level selection of different grade book applications, student information systems, and learning management systems. The configuration data 104, which identifies the selected gradebook application, learning management system and student information system to be used in assessing risk for a particular course, may be stored in a persistent memory of the computer system 100.

In addition to identifying the selected grade book application 110, student information system 112, and learning management system 114, the configuration data 104 may further comprise information concerning a selected identity provider (IP) to use for identity management, a demographic expression to use for evaluating whether a student is at risk based on his or her background, and an indication of whether or not the system is to use academic preparation data in generating signals for each student. Information about the course itself and its instructor may also be included in the configuration data 104.

In the present embodiment, the system 100 further comprises a first adapter 107 that receives first input data from the selected grade book application 110 identified in the configuration data 104 and transforms the first input data into first data of a risk model specific to the particular course. The first input data may comprise data indicative of the performance of the students in the particular course.

A second adapter 108 receives second input data from the selected student information system 112 identified in the configuration data 104 and transforms the second input data into second data of the risk model. The second input data may comprise data indicative of student demographics and/or academic preparation.

A third adapter 109 receives third input data from the selected learning management system 114 identified in the configuration data 104 and transforms the third input data into third data of the risk model. The third input data may comprise data indicative of student effort.

Input data may also be received from other information sources 116. For example, data may be received from an identity provider (IP) identified in the configuration data 104.

The input data is received by a signal generation module 102. A risk calculator 106 then generates for each student in the course, based at least on the received first, second and third data of the risk model, a signal indicative of a likelihood of the student failing the particular course.

The signals generated by the signal generation module 102 may be transmitted to a core services component 118, which may generate a user interface (UI) for interacting with the system from one or more devices 120, 122, such as desktop computers, laptop computers, tablet computers, mobile telephones, or any other type of communications device. The core services component 118 may execute on the same computer system as the signal generation module 102, adapters 107-109 and configuration data 104, or it may execute on a different computer system connected to the other components via a network or other connection. In one embodiment, the user-interface presented by the core services component 118 may comprise a web-based interface that users at devices 120, 122 may access via a network, such as the Internet, an intranet or other communications network.

In one embodiment, users of devices 120 and 122 may be faculty members of an educational institution that are interested in assessing the risk of their students failing a particular course. The core services component 118 of the system 100 may enable such users to access the system and view the signals generated by the module 102 via one or more user interface screens or views.

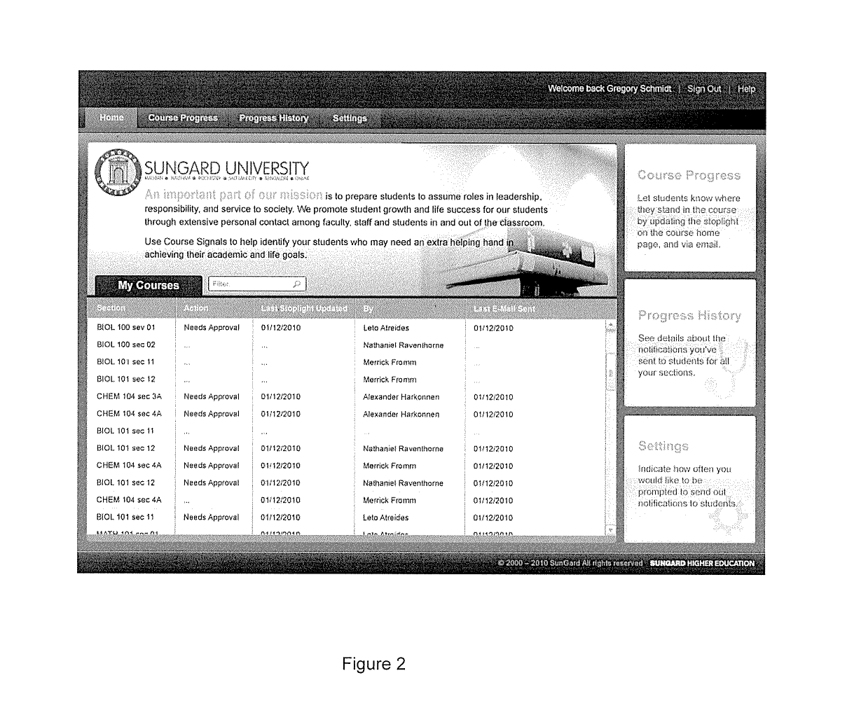

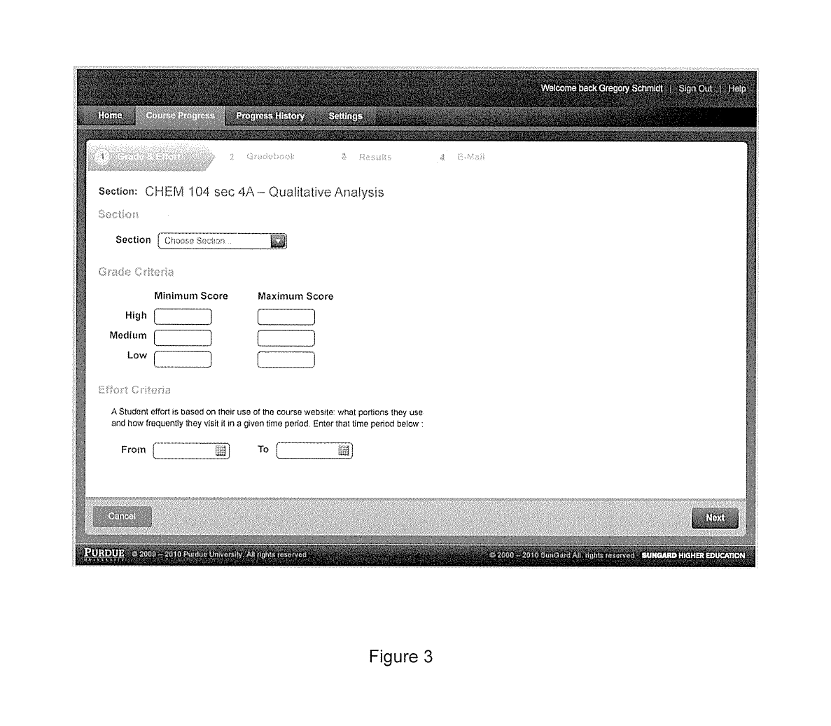

For example, FIG. 2 illustrates one embodiment of a view of a home page generated by the system 100 for a faculty member of an educational institution. As shown in FIG. 3, when a faculty member accesses the system 100, the faculty member may be presented with a list of sections that the faculty member teaches and the last actions taken for those sections. The length of the list may vary according to the number of courses taught by the faculty member.

In one embodiment, the system's user interface may also allow a faculty member to establish parameters for signal generation. For example, the system may allow the faculty member to set grade point ranges and dates for activity in the selected learning management system 114. For example, FIG. 3 shows one embodiment of a user interface screen that a faculty member may use to set grade point ranges and dates for activity in the selected learning management system 114 to which the signal generation module 102 interfaces.

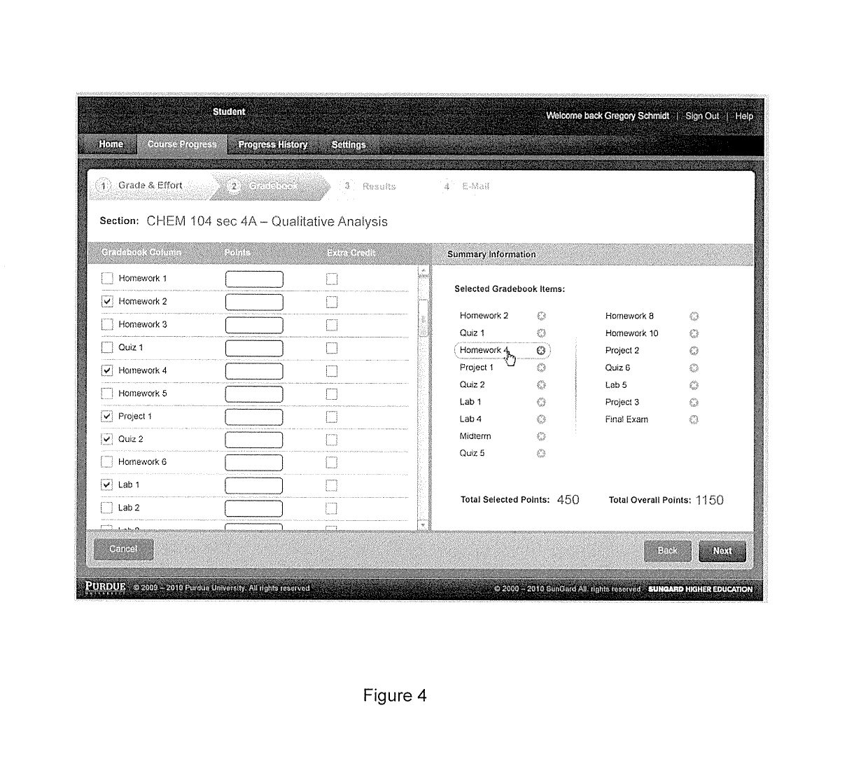

The system 100 may also enable the faculty member to select grade book columns used when calculating risk signals. For example, FIG. 4 illustrates one embodiment of a user interface screen that allows a faculty member to select grade book columns from the selected grade book application 110 to which the signal generation module 102 interfaces.

In one embodiment, the signals generated by the signal generation module 102 are presented in the form of red, yellow or green indicators, each of which reflects a different level of risk that a particular student may fail the course in question. A red signal indicator may represent a “high” risk of failure, a yellow signal indicator may represent a “medium” risk of failure, and a green signal indicator may represent a “low” risk of failure. In one embodiment, a calculated risk signal may be a value from 1 to 6, which is generated by the signal generation module 102. The signal generation module 102 may create a low/medium/high risk grouping and a low/high effort grouping that is cross-tabbed with the risk grouping. For example, high risk may be cross-tabbed with high effort or low effort. Once risk signals have been generated, a faculty member may notify a student of that particular student's risk signal. In one embodiment, a faculty member may compose electronic messages for red, yellow and green risk signals, and send the appropriate electronic message to the corresponding student.

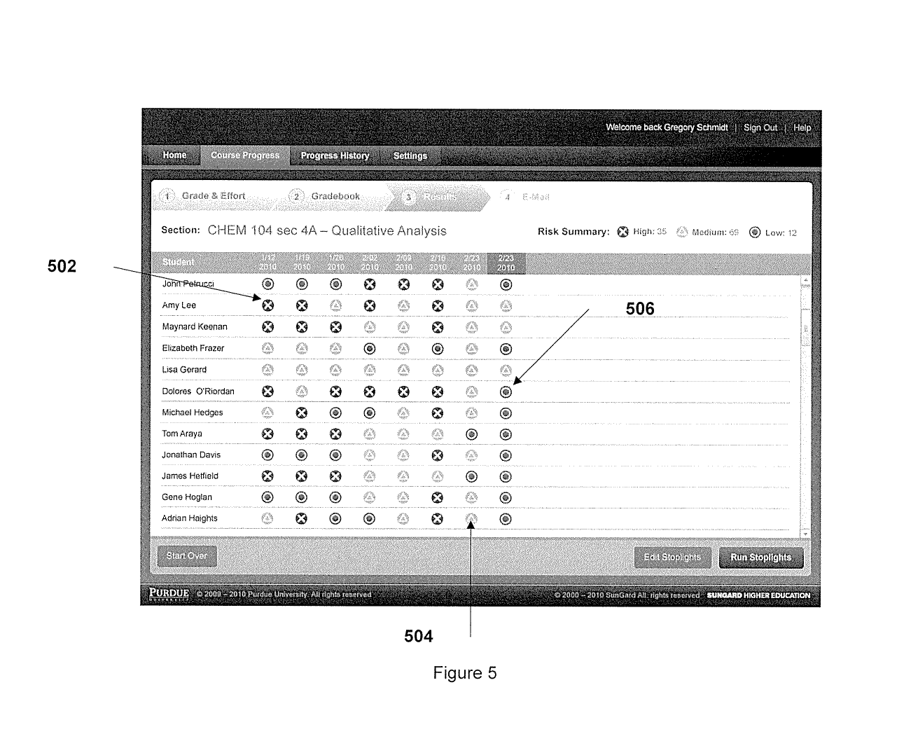

In one embodiment, a faculty member may wish to review the signals prior to notifying any students. FIG. 5 illustrates one embodiment of a user interface screen that a faculty member can use to view the risk signals generated for each student in a course.

In FIG. 5, indicators 502, 504, and 506 may be used to reflect the level of risk that a particular student may fail the course in question. In one embodiment, indicator 502 may be displayed with a red color and may contain an “x” marking. Indicator 502 may be used to indicate a “high” risk of failure in the course. Indicator 504 may be displayed with a yellow color and may contain a “triangle.” It may be used to indicate a “medium” risk of failure of the course. Indicator 506 may be displayed with a green color and may contain a “circle.” It may be used to indicate a “low” risk of failure of the course.

In an alternative embodiment, indicators 502, 504 and 506 may be comprised of only colors, or only shapes, in order to indicate the level of risk that a particular student may fail a particular course. Indicators 502, 504, and 506 may be any color, letter, number, symbol, shape, or other identifier that is capable of conveying the different levels of risk of a student failing a particular course.

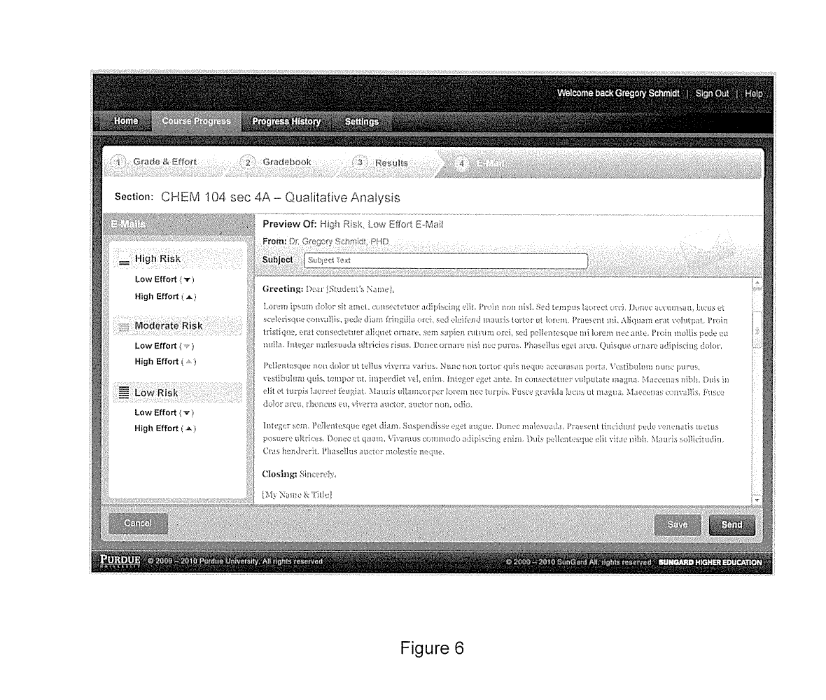

FIG. 6 illustrates one embodiment of a user interface screen that allows a faculty member to send a notification of a risk signal to a student. Notifications may be sent via electronic mail, text message, facsimile, instant message or any other method of communication.

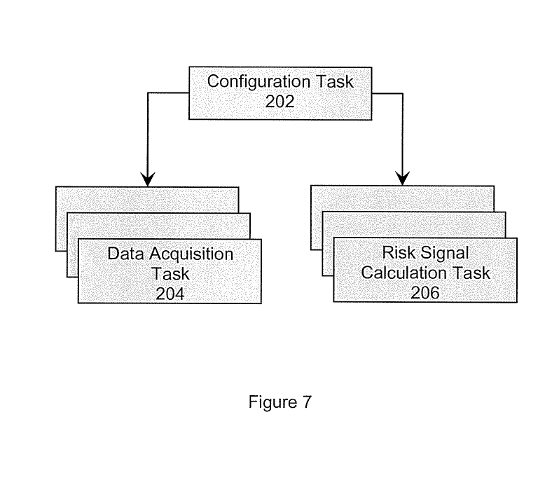

In one embodiment, in order to calculate the risk of a student failing a particular course, the signal generation module 102 supports a configuration task 202, a data acquisition task 204 and a risk signal calculation task 206. FIG. 7 illustrates these tasks. The arrows in the diagram represent an ordering dependency in this embodiment. For example, the arrow between the configuration task 202 and the data acquisition task 204 indicates that the configuration task must be completed before the data acquisition task can be started. On the other hand, data acquisition task 204 and risk signal calculation task 206 may proceed in parallel, as indicated by the absence of any arrow between them. Moreover, multiple risk signal calculation tasks 206 and multiple data acquisition tasks 204 may proceed in parallel.

In one embodiment, the configuration task 202 may include establishing both configuration data for the signal generation module 102 generally and establishing configuration data for a specific course. For example, for the configuration of the signal generation module 102 generally, the configuration task may establish:
a Student Information System (SIS) adapter to use for obtaining demographic and academic preparation data from the selected SIS;
a URL and credentials for accessing the selected SIS,
an identity provider (IP) adapter to use,
a URL and credentials for accessing the IP,
a demographic expression to use for evaluating whether a student is at risk based on his or her background, and
an indication whether to use academic preparation data in computing signals.
   This configuration data may be stored in a persistent store (memory) and may be used in later tasks.

With respect to a particular course, the configuration task 202 may also establish:
a learning management system (LMS) adapter to use when obtaining effort data from the selected LMS,
a URL for the chosen LMS,
a grade book application adapter to use when obtaining performance data from the selected grade book application, and
a URL for the chosen grade book application.

By associating the learning management system adapter with a particular course and not a particular institution, the learning management system may be selected at the individual course level and not for an entire institution. An institution may provide multiple learning management systems and let the instructors choose which one to use. Thus, system 100 may be used to identify at-risk students in one course using one learning management system as a data source, and may also identify at-risk students in a different course using a different learning management system as a data source.

While SIS, LMS and grade book applications are given as examples, it is contemplated that the signal generation module 102 may also obtain data from other sources. In some embodiments, the configuration task 202 may establish data sources that may be either external or internal to a particular institution.

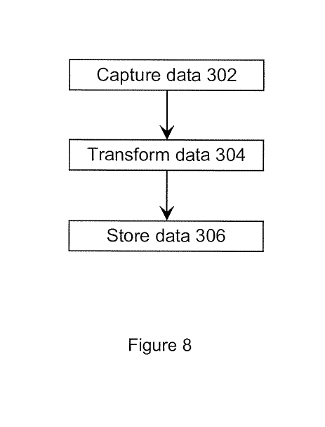

FIG. 8 illustrates further details of steps that may be performed as part of the data acquisition task 204 of FIG. 7. For example, as shown in FIG. 8, data acquisition task 204 may further comprise capturing the input data from data sources (step 302), such as the selected gradebook application, SIS and LMS, transforming the input data into data of an abstract risk model (step 304), and storing the risk calculation data in memory (step 306).

The capturing 302 and transforming 304 steps may be accomplished by a set of adapters. The adapters provide access to data and functionality of different systems and transform the data used to calculate risk signals into a defined standard abstract model. Each particular adapter may implement access to a particular product. In an alternate embodiment, an adapter may allow access to a plurality of products.

In one embodiment, each adapter comprises a Java library, or other dynamically loadable library, that implements a defined adapter interface. The adapters transform and store the data they acquire into a defined standard abstract model for the risk data. At step 306, once the input data has been captured and transformed, it is stored for use in one or more risk signal calculation tasks 206.

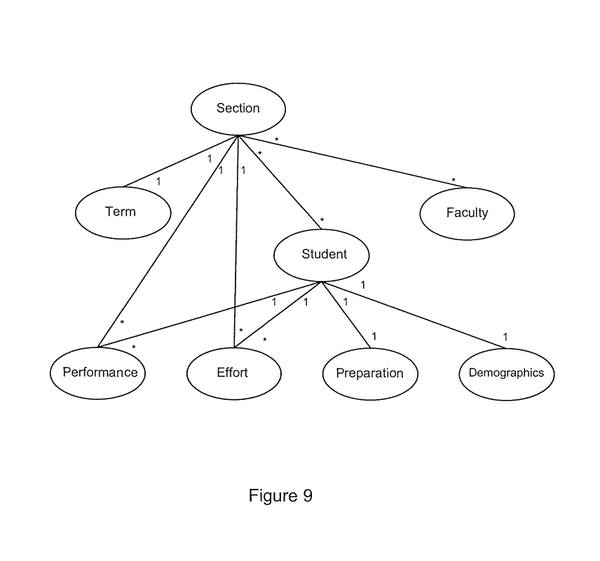

Central to integrating many different systems is the abstract model for risk data. FIG. 9 illustrates one embodiment of an abstract model for risk data that may be implemented by the system 100. In one embodiment, the abstract model may define the minimal amount of information required to support the application functionality. The abstract model may define entities for a section, an academic term, a student, a faculty member, performance, effort, academic preparation and demographics. The abstract model defines relationships between the entities. For example, a section is given in a term, has one or more faculty members teaching the section and multiple students are enrolled in the section. A faculty member may teach zero or more sections. A student is enrolled in one or more sections. A student has academic preparation data and demographic data. A student also may have performance data and effort data for a particular section. Signals for the students enrolled in a section are calculated by accessing entities and relationships in the abstract model.

An adapter essentially maps between data defined in the integrated system (e.g., gradebook application, SIS or LMS) and the abstract model. The adapter interfaces operate on or return objects supporting the interfaces of the abstract model. In one embodiment, each adapter comprises a Java class library that implements one or more adapter interfaces. The adapter may be packaged as a .jar file. The adapter is designed to hide system integration dependencies from the signal generation module 102.

In one embodiment, there are three main types of adapters: (1) an adapter for integrating an LMS, (2) an adapter for integrating a grade book, and (3) an adapter for integrating a SIS. Each type may be represented by a Java interface. One Java class library may implement more than one type of adapter. An adapter may use any code it needs to implement the interface. For example, the adapter for a particular LMS may use client libraries of that LMS in its implementation. In another embodiment, there may be a single adapter configured to integrate with an LMS, grade book, and SIS.

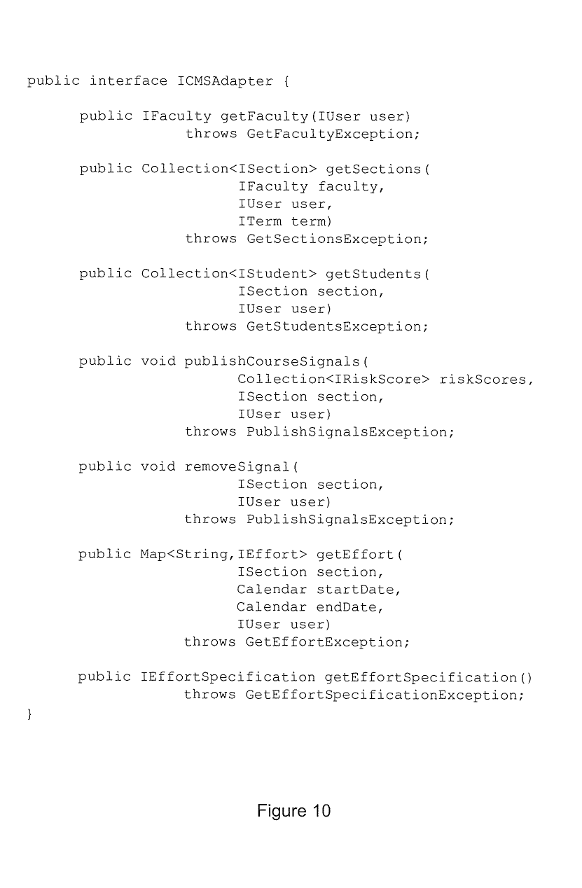

FIG. 10 illustrates one embodiment of an interface to a learning management system adapter. In FIG. 10, the getFaculty operation returns the faculty object associated with a user. The getSections operation returns the sections associated with a faculty member. The get Students operation returns the students enrolled in a section. The publishCourseSignals operation causes the results of signals calculation to be published to the Learning Management System so that the student is informed of the intervention results in the system. The removeSignal operation removes the signals established in the Learning Management System for the section. The getEffort operation returns the LMS usage for all students enrolled in a section between startDate and endDate. The getEffortSpecification allows the agent to introspect the adapter for the effort data that the implementation supports.

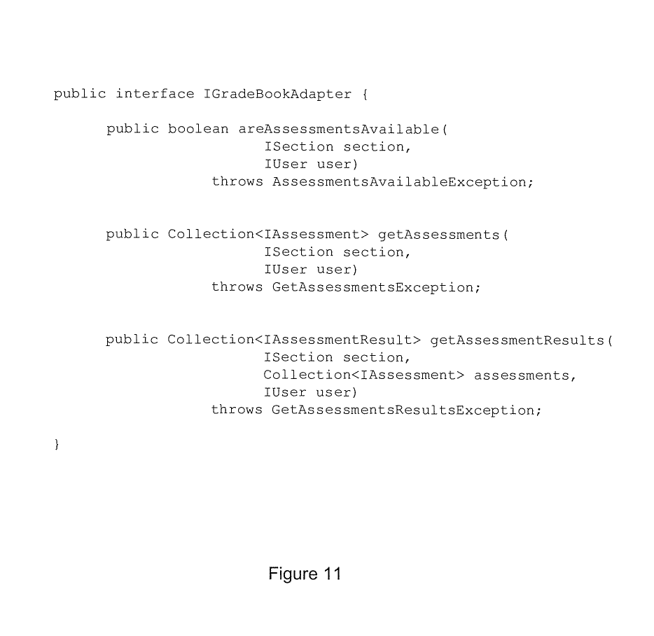

FIG. 11 illustrates one embodiment of an interface to a grade book adapter. In FIG. 11, the areAssessmentsAvailable operation checks if the grade book is set up for a given section. The getAssessments operation returns the assessments for a given section. The getAssessmentResults operation returns all of the scores of all of the students in a section for the assessments.

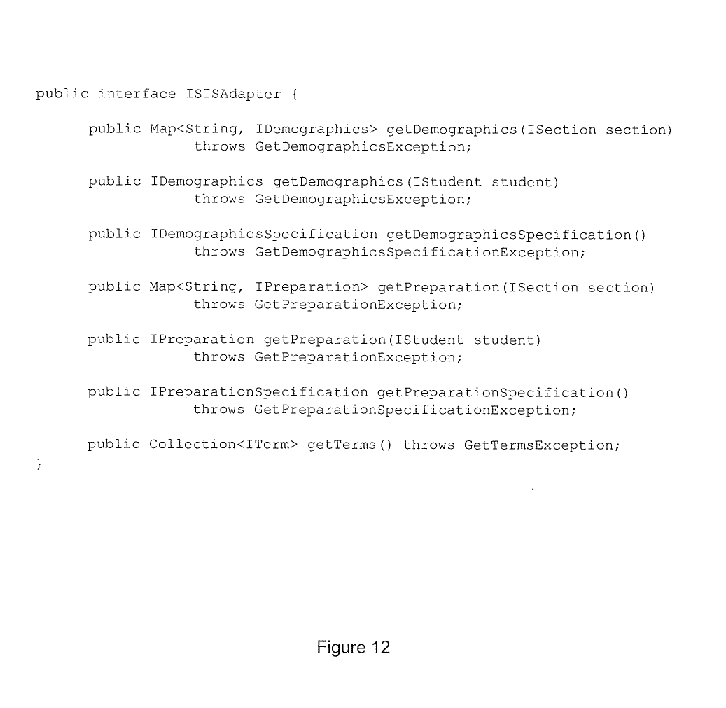

FIG. 12 illustrates one embodiment of an interface to a student information system. In FIG. 12, the getDemographics operation returns the demographic data for all of the students enrolled in the section. The getDemographics operation with a single student as a parameter returns the data for that particular student. The getDemographicsSpecification allows the agent to introspect the adapter for the demographic data that the implementation supports. The getPreparation operation returns the preparation data for all of the students enrolled in the section. The getPreparation operation with a single student as a parameter returns the data for that student. The getPreparationSpecification allows the processor to introspect the adapter for the preparation data that the implementation supports. The getTerms operation returns the academic terms defined by the Student Information System.

By defining standard adapter interfaces and a defined standard abstract model for the data used to calculate risk signals, the system 100 may work with multiple sources of input data. For example, the signal generation module 102 may operate with multiple grade book applications, Student Information Systems and Learning Management Systems. All differences between the different grade book applications, SIS and LMS products are hidden by the adapters.

While the adapters are described as operating in association with the signal generation module 102, it is contemplated that the adapters may also operate independently of the signal generation module 102. For example, in an alternate embodiment, products 110, 112 and 114 may transmit input data to the signal generation module 102 already in the defined standard abstract model.

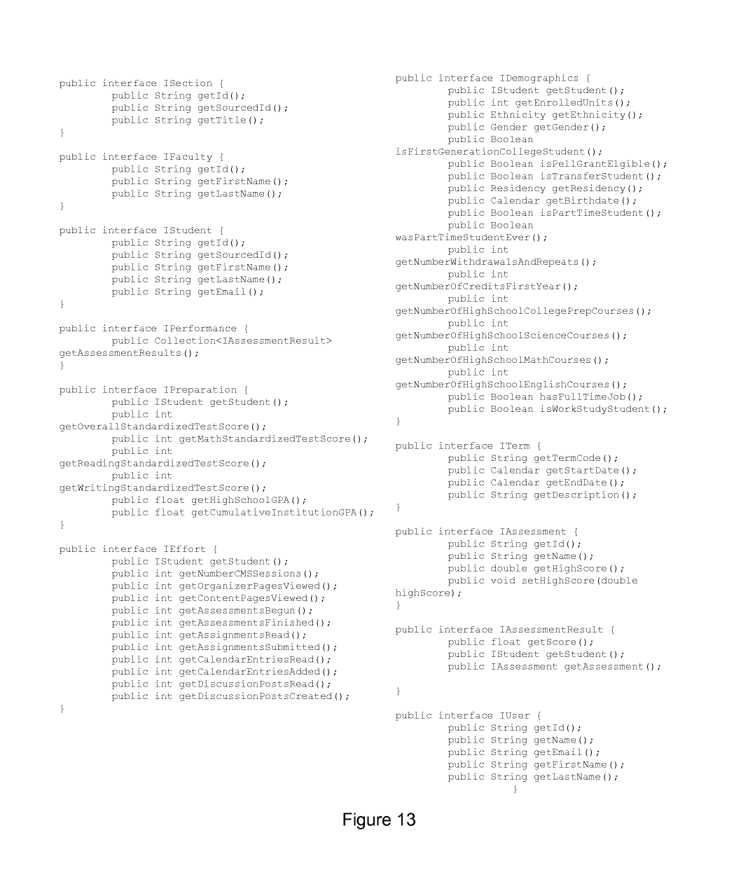

FIG. 13 illustrates one embodiment of a group of interfaces that define the abstract model for risk data used by the signal generation module 102 (e.g., the model shown in FIG. 9). In this embodiment, the abstract model is defined by a set of minimal Java interfaces. The interfaces may only define the operations and attributes on which the signal generation module 102 depends. While concrete implementations of these interfaces may carry additional data, the signal generation module 102 may only depend on these interfaces. They represent the contract between the signal generation module 102 and the various adapters.

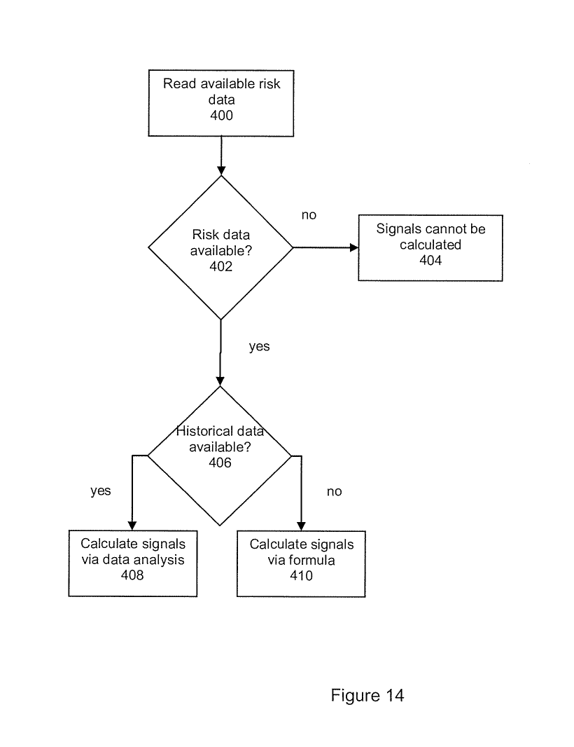

FIG. 14 illustrates one embodiment of a method of calculating risk signals for a group of students taking a course at an educational institution. A set of assessments and a date range are inputs to the calculation. At step 400, the persistent store is read to determine whether any risk data are available in the requested date range for the students in the course.

At step 402, if no risk data are available, control passes to step 404 where no risk signals are calculated. If risk data are available, control passes to step 406. In the embodiment shown in FIG. 14, at step 406, the signal generation module 102 determines which of two methods to use for calculating risk signals, based on whether historical training data is available. Historical training data is data for the particular course from previous academic terms. Historical training data may also be data for a particular instructor from previous academic terms. Historical training data may include performance, effort, demographic and preparation data as well as the final grades in the course from previous academic terms. The final grades represent success or failure in the course. If historical training data is determined to be available at step 406, risk signals are calculated by analyzing the historical training data using machine learning/data mining techniques (step 408). Machine learning techniques create a predictive model by analyzing a historical data set in which an attribute is designated as a label. Then, the predicative model is used to predict the value of the label, given a data set without a value for the label. If historical training data is not available, risk signals are calculated using a formula (step 410). For example, after initial installation of the system 100, historical data may not be available, and therefore risk signals may need to be calculated using a formula. The system 100 stores collected input data and generated risk signals to provide historical training data for subsequent offerings of the same course.

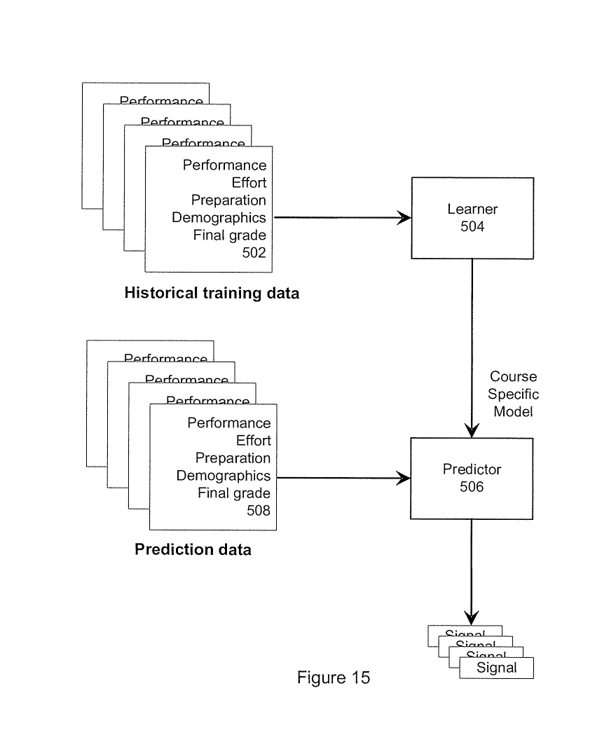

FIG. 15 illustrates one embodiment of a method of calculating risk signals using historical training data. In one embodiment, signal generation module 102 embeds a RapidMiner machine learning Java class library. It is contemplated that signal generation module 102 may embed any machine learning library. Historical training data 502 may be passed to a learning operator 504 to produce a course specific model. The final grade in the historical training data 502 is used as the measure of success in the historical training data. A prediction operator 506 consumes the course specific model and the current input data 508 for the students in a particular course. Based on the course specific model, risk signals are generated for each student. In particular, using machine learning and/or data mining techniques, a final grade is predicted and, in one embodiment, is turned into a red, yellow or green risk signal.

In one embodiment, a red signal may indicate that a student is failing a particular course. A green signal may indicate that a student is passing a particular course. A yellow signal may indicate that a student is borderline and may be in danger of failing a particular course. In an alternate embodiment, risk signals may not be limited to red, green and yellow identifiers, and may comprise any indication system that can be used to notify a user that s/he is in danger of failing a particular course.

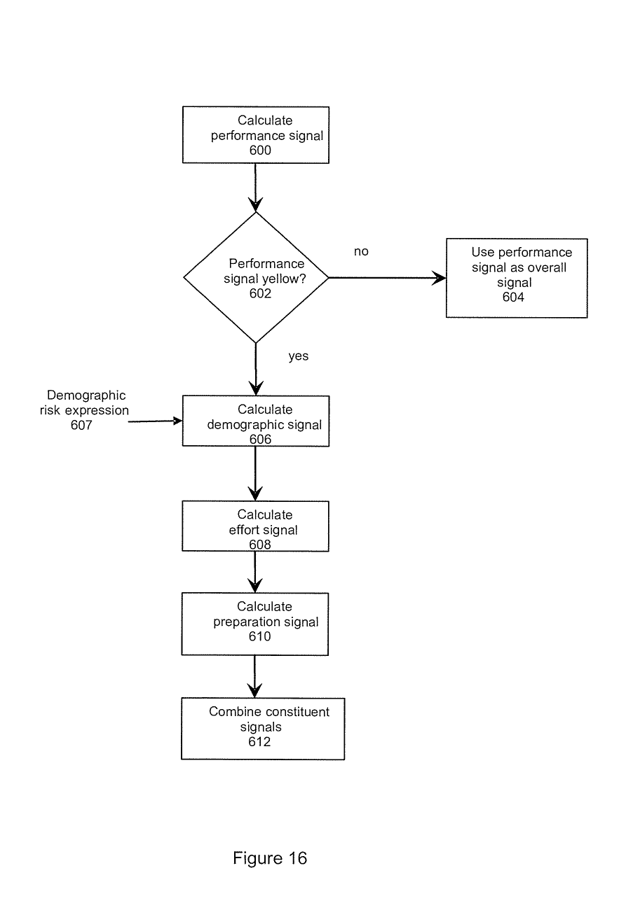

If historical training data is not available, at step 410, risk signals may be calculated with a formula. FIG. 16 provides further details of one embodiment of calculating risk signals using a formula.

At step 600, a performance signal is calculated using data received from the selected grade book application. In one embodiment, the performance signal is calculated by placing each student's grades into risk bands established by the instructor. At step 602, if the student's performance as indicated by the performance signal represents passing or failing (i.e., a green or red performance signal) according to the instructor's grade ranges for that particular course, then the overall risk signal for the student is made equal to the performance signal. If, however, at step 602, the student's performance signal is yellow, then other factors are considered. The student's demographics, effort and preparation are considered at subsequent steps 606, 608 and 610. In one embodiment, a demographic signal is calculated using a risk expression of demographic variables established by the institution at step 607. For example, an institution may consider males under the age of 18 who are also first generation college students to be at risk. The demographic risk expression in that case would be ((age<18) and (gender=male) and first generation). The demographic expression may be evaluated against the student's demographic data using a logic system. In one embodiment, the demographic expression is evaluated against the student's demographic data using ternary logic. Ternary logic extends standard Boolean logic with unknown values. For example, the expression ((age<18) and (gender=male) and first generation) evaluates a true for a 17 year old male student whose parents did not go to college. On the other hand, it evaluates to unknown if the age of the student is unknown. The effort and preparation scores are calculated by comparing the student against his or her fellow students' effort and preparation data in the course. For example, students whose effort scores are more than a half a standard deviation below the mean may be considered at risk for effort. Similarly, students whose preparation scores are more than a half a standard deviation below the mean may be considered at risk for preparation. At step 612, all of the performance, demographic, preparation and effort signals may be combined to calculate an overall signal. Risk signals may be calculated using a regression model, such as linear regression or logistic regression, machine learning, decision tree learning, or other predictive models, or any combination or weighted combination thereof.

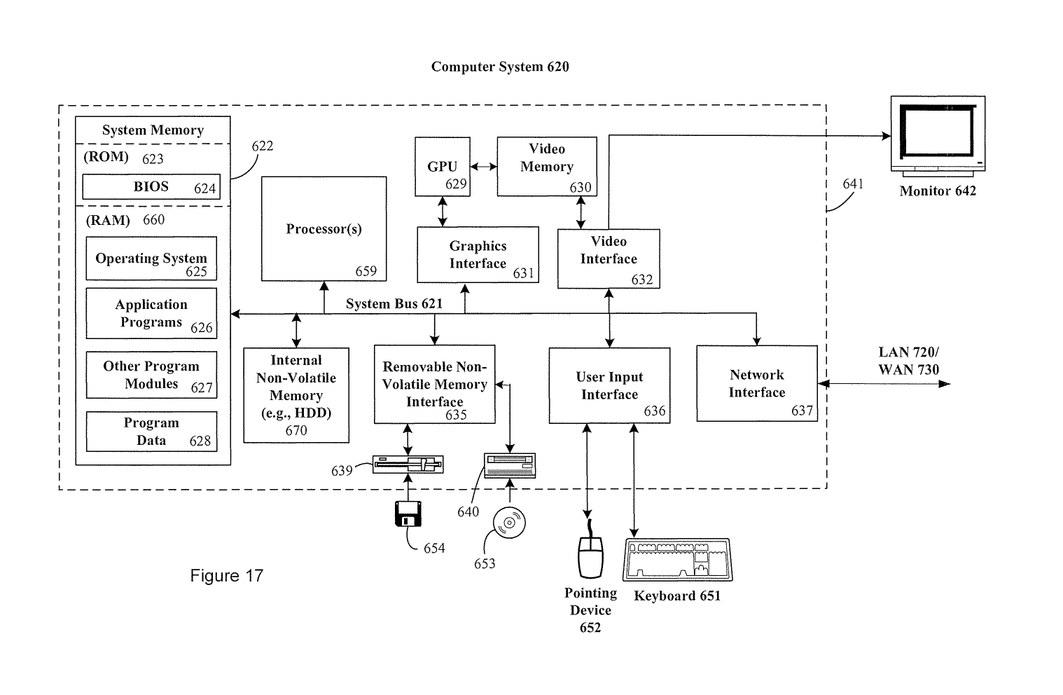

FIG. 17 is a block diagram of an example computer system 620 on which the system 100 described above and/or all or some of its various components may be implemented. The computer system 620 is only one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIG. 17. In some embodiments, the various depicted computing elements may include modules or components configured to instantiate specific aspects of the present disclosure. For example, the terms “module” or “component” used in this description may include specialized hardware components configured to perform function(s) by firmware or switches. In other example embodiments, the terms “module” and “component” may include a general purpose processor, memory, etc., configured by software instructions that embody logic operable to perform function(s). In example embodiments where modules or components include a combination of hardware and software, an implementer may write source code embodying logic and the source code can be compiled into machine readable code that can be processed by the general purpose processor. Since the state of the art has evolved to a point where there is little difference between hardware, software, or a combination of hardware/software, the selection of hardware versus software to effectuate specific functions is a design choice left to an implementer. More specifically, a software process can be transformed into an equivalent hardware structure, and a hardware structure can itself be transformed into an equivalent software process. Thus, the selection of a hardware implementation versus a software implementation is one of design choice and left to the implementer.

In FIG. 17, the computer system 620 comprises a computer 641, which typically includes a variety of computer readable media. Computer readable media can be any available media that can be accessed by computer 641 and includes both volatile and nonvolatile media, removable and non-removable media. The system memory 622 includes computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, is typically stored in ROM 623. RAM 660 typically contains data and/or program modules that are immediately accessible to and/or presently being operated on by processing unit 659. By way of example, and not limitation, FIG. 6 illustrates operating system 625, application programs 626, other program modules 627, and program data 628. As a further example, the adapters 107, 108, 109 and signal generation module 102 of FIG. 1 may, in one embodiment, be implemented as application programs 626 and/or program modules 627. Input data received by the signal generation module 102 may be stored in the system memory 622, as well as in any of a variety of non-volatile memory media discussed below.

The computer 641 may also include other removable/non-removable, volatile/nonvolatile computer storage media. By way of example only, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Magnetic disk drive 639 and optical disk drive 640 are typically connected to the system bus 621 by a removable memory interface, such as interface 635. The drives and their associated computer storage media discussed above and illustrated in FIG. 6, provide storage of computer readable instructions, data structures, program modules and other data for the computer 641. By way of example, configuration data 104 of FIG. 1 may be stored persistently in any one of the non-volatile memory media described above.

A user may enter commands and information into the computer 641 through input devices such as a keyboard 651 and pointing device 652, commonly referred to as a mouse, trackball or touch pad. Other input devices (not shown) may include a microphone, joystick, game pad, satellite dish, scanner, or the like. These and other input devices are often connected to the processing unit 659 through a user input interface 636 that is coupled to the system bus, but may be connected by other interface and bus structures, such as a parallel port, game port or a universal serial bus (USB). The computer may connect to a local area network or wide area network, such as LAN 720 and/or WAN 730, through a network interface or adapter 637. For example, the selected grade book application 110, SIS 112 and LMS 114 may be running on other computers at an educational system and may be connected to a network (e.g., LAN 720). The adapters 107, 108 and 109 may receive input data from each of the selected gradebook application 110, SIS 112 and LMS 114 from the network via the network interface 637. In other embodiments, one or more of the gradebook application 110, SIS 112 and LMS 114 may be running as other application programs 626 or program modules 627 on the same computer 641 as the adapters 107, 108, 109 and signal generation module 102. Similarly, the core services component 118 may be running as another application program 626 on the computer 641 and may communicate with user devices 120 and 122 via the network interface 637 as well. Alternatively, in other embodiments, the core services component 118 may be implemented on a separate computer system and the signal generation module 102 may transmit its calculated risk signals to that other computer system via the network interface 637.

As is apparent from the above, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language. When implemented on a general-purpose processor, the program code may combine with the processor to provide a unique apparatus that operates analogously to specific logic circuits. As used herein, the term “computer-readable medium” does not include a signal.

As the foregoing illustrates, the present invention is directed to a system and method for assessing a likelihood of a student of an educational institution failing a particular course taken by the student. Changes may be made to the embodiments described above without departing from the broad inventive concepts thereof. Accordingly, the present invention is not limited to the particular embodiments disclosed, but is intended to cover all modifications that are within the spirit and scope of the invention as defined by the appended claims.

What is claimed:

1. A computer-based system for assessing a likelihood of a student of an educational institution failing a particular course taken by the student, the system comprising:
a processor;
a memory;
configuration data, stored in the memory, which identifies, for the particular course, a selected one of a plurality of grade book applications, a selected one of a plurality of student information systems, and a selected one of a plurality of learning management systems;
a first adapter that executes on the processor and that receives first input data from the selected grade book application identified in said configuration data and transforms the first input data into first data of a risk model specific to the particular course;
a second adapter that executes on the processor and that receives second input data from the selected student information system identified in said configuration data and transforms the second input data into second data of the risk model;
a third adapter that executes on the processor and that receives third input data from the selected learning management system identified in said configuration data and transforms the third input data into third data of the risk model; and
a risk calculator that executes on the processor and generates, based at least on the first, second and third data of the risk model, a signal indicative of a likelihood of the student failing the particular course.

2. The system recited in claim 1, wherein the first, second and third adapters are selected based on the configuration data.

3. The system recited in claim 1, wherein the generated signal comprises a predicted final grade for the course.

4. The system recited in claim 1, wherein the first input data comprises data indicative of the performance of the student in the particular course.

5. The system recited in claim 1, wherein the second input data comprises data indicative of student demographics and academic preparation.

6. The system recited in claim 1, wherein the third input data comprises data indicative of student effort.

7. The system of claim 1, wherein the signal is calculated using a risk formula.

8. The system of claim 1, wherein the signal is calculated by machine learning techniques.

9. The system of claim 1, wherein the signal is calculated by comparing the first, second, and third data of the risk model to historical data collected from at least one previous academic term for the course.

10. The system of claim 1, wherein each adapter comprises a Java library having a defined interface.

11. A computer-implemented method for assessing, in a computer system comprising a processor and a memory, a likelihood of a student of an educational institution failing a particular course taken by the student, the method comprising:
storing in the memory configuration data that identifies, for the particular course, a selected one of a plurality of grade book applications, a selected one of a plurality of student information systems, and a selected one of a plurality of learning management systems;
receiving, via a first adapter that executes on the processor, first input data from the selected grade book application identified in said configuration data and transforming the first input data into first data of a risk model specific to the particular course;
receiving, via a second adapter that executes on the processor, second input data from the selected student information system identified in said configuration data and transforming the second input data into second data of the risk model;
receiving, via a third adapter that executes on the processor, third input data from the selected learning management system identified in said configuration data and transforming the third input data into third data of the risk model; and
generating, by the processor, based on at least the first, second and third data of the risk model, a signal indicative of a likelihood of the student failing the particular course.

12. The method recited in claim 11, further comprising selecting the first, second and third adapters based on the configuration data.

13. The method recited in claim 11, wherein the generated signal comprises a predicted final grade for the course.

14. The method recited in claim 11, wherein the first input data comprises data indicative of the performance of the student in the particular course.

15. The method recited in claim 11, wherein the second input data comprises data indicative of student demographics and academic preparation.

16. The method recited in claim 11, wherein the third input data comprises data indicative of student effort.

17. The method of claim 11, wherein said generating comprises calculating the signal using a risk formula.

18. The method of claim 11, wherein said generating comprises calculating the signal using machine learning techniques.

19. The method of claim 11, wherein said generating comprises calculating the signal by comparing the first, second, and third data of the risk model to historical data collected from at least one previous academic term for the particular course.
